(19) United States
(12) Patent Application Publication
(10) Pub. No.: US 2015/0074202 A1
(43) Pub. Date: Mar. 12, 2015

(54) PROCESSING ACTION ITEMS FROM MESSAGES

(71) Applicant: Lenovo (Singapore) Pte. Ltd., Singapore (SG)

(72) Inventors: Russell Speight VanBlon, Raleigh, NC (US); Rod D. Waltermann, Rougemont, NC (US); John Carl Mese, Cary, NC (US); Arnold S. Weksler, Raleigh, NC (US); Nathan J. Peterson, Durham, NC (US)

(73) Assignee: Lenovo (Singapore) Pte. Ltd., Singapore (SG)

(21) Appl. No.: 14/022,677

(22) Filed: Sep. 10, 2013

(51) Int. Cl. H04L 12/58

(52) U.S. Cl. CPC H04L 51/04
USPC 709/206

(57) ABSTRACT

An aspect provides a method, including: receiving, at an information handling device, a message directed to a human recipient; processing, using one or more processors of the information handling device, the message to identify one or more action items contained in content of the message; and executing one or more additional actions based on the one or more action items identified from the content of the message. Other aspects are described and claimed.

### BACKGROUND

Information handling devices (“devices”), for example laptop and desktop computers, tablet computers, smart phones, e-readers, etc., are often used in a context where messages are received at the device. A typical scenario includes for example a user receiving a text message, an email message, or a voicemail message.

Devices provide a variety of notification mechanisms to notify a user that a message has been received. For example, certain devices provide audible notifications such as tones or sounds played, visual notifications such as a flashing light, haptic notifications, or suitable combinations of notifications. The user then opens a message application or looks at a message preview to gain an understanding of the message content. Certain message applications provide a small set of pre-programmed options the user may select, for example call back, message, ignore, etc. These options may be executed via a single click, e.g., on an appropriate soft button on a touch screen of the device.

### BRIEF SUMMARY

In summary, one aspect provides a method, comprising: receiving, at an information handling device, a message directed to a human recipient; processing, using one or more processors of the information handling device, the message to identify one or more action items contained in content of the message; and executing one or more additional actions based on the one or more action items identified from the content of the message.

Another aspect provides an information handling device, comprising: one or more processors; a memory device accessible to the one or more processors and storing code executable by the one or more processors to: receive a message directed to a human recipient; process the message to identify one or more action items contained in content of the message; and execute one or more additional actions based on the one or more action items identified from the content of the message.

A further aspect provides a program product, comprising: a storage device having computer readable program code stored therewith, the computer readable program code comprising: computer readable program code configured to receive, at an information handling device, a message directed to a human recipient; computer readable program code configured to process, using one or more processors of the information handling device, the message to identify one or more action items contained in content of the message; and computer readable program code configured to execute one or more additional actions based on the one or more action items identified from the content of the message.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example operating environment including multiple monitors.

FIG. 3 illustrates an example method of processing action items from messages.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When receiving a message directed to a human recipient (e.g., text based messages such as emails, SMS texts, etc., and/or audio messages, e.g., voicemail—messages not directed to the machine (e.g., control messages, etc.)) on a device, the user is unaware of any action required until reading (or hearing) the message. Such information, i.e., message contents requesting user action (e.g., scheduling of events such as calendar entries, providing responses to messages, completing time or location sensitive tasks, and the like) may be included in the message but nonetheless go unnoticed by the user. Even if the user reads the message, the message may contain other text or multiple action items, or the user could be busy or for other reasons overlook action items.

The requirement that the user actually manually process (e.g., read, listen to) the message causes the action item to be overlooked by the user and leads to missed opportunities, frustration, etc. For example, if a user receives a text message from his or her partner asking them to pick up an item from the store on the way home, and if the user receives more than one message at the same time or is busy with other things when the message is received by the device, the user may not read the message until it is too late, e.g., he or she has already past the store, arrived home, etc. If a message is received while traveling, a user may not receive it until reaching the destination when the opportunity to do an action item has passed. As another example, if someone's boss sends an email with an action item, the user on the receiving end may not be aware that the message contains an action item until reading the message. Since many messages (e.g., emails) can contain multiple threads, it is not uncommon to miss an action item somewhere within the message even if it is read or reviewed promptly.

Accordingly, an embodiment parses messages that are received by the device automatically and attempts to extract action item(s) from each message. An action item is message content that is utilized by an embodiment to formulate and execute additional action(s) based on a prior association between the message content and predefined actions which have been automated. Some examples of action items include a message requesting a meeting with a user at a specific time, a message including a request that the user perform some task, a message requesting a user respond to the message, etc.

When a message is received and an action item is identified, an additional action may be executed by an embodiment. Some examples of additional actions include but are not necessarily limited to determining the urgency of an action item, determining if the sender is a high priority contact, notifying the receiving user of the action item's presence within the message, addition of the action item into a reminder (e.g., a calendar entry), or creating a response based on the action item of the message.

The illustrated example embodiments will be best understood by reference to the figures. The following description is intended only by way of example, and simply illustrates certain example embodiments.

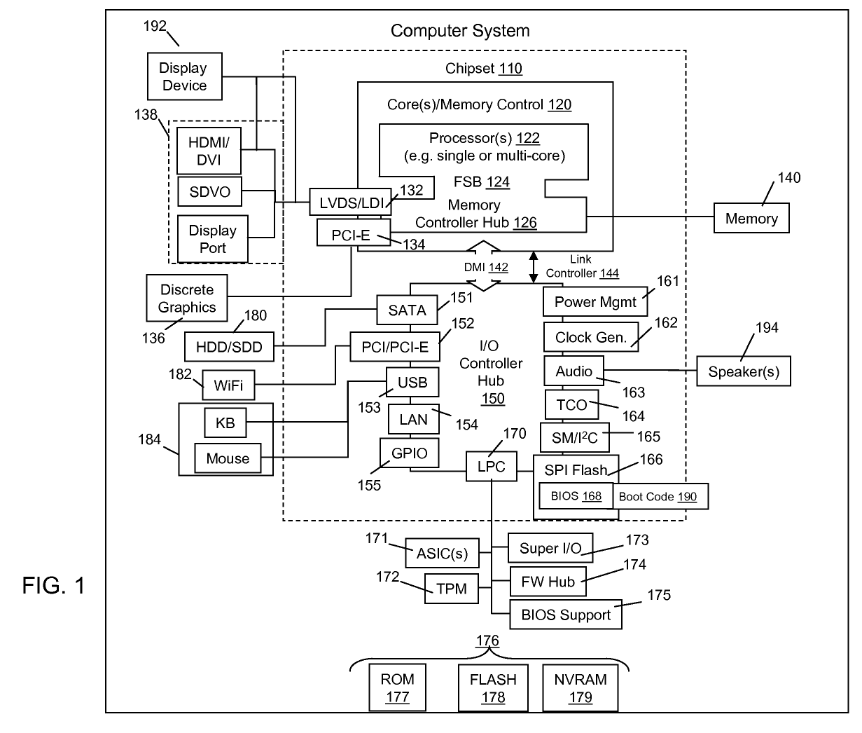

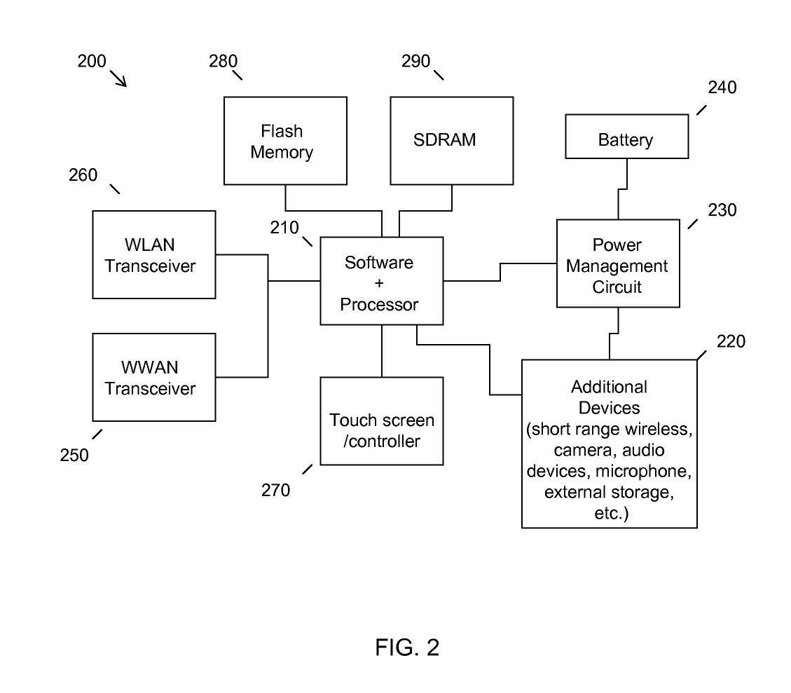

Referring to FIG. 1 and FIG. 2, while various other circuits, circuitry or components may be utilized in information handling devices, with regard to smart phone and/or tablet circuitry 200, an example illustrated in FIG. 2 includes a system on a chip design found for example in tablet or other mobile computing platforms. Software and processor(s) are combined in a single chip 210. Internal busses and the like depend on different vendors, but essentially all the peripheral devices (220) such as a camera may attach to a single chip 210. In contrast to the circuitry illustrated in FIG. 1, the circuitry 200 combines the processor, memory control, and I/O controller hub all into a single chip 210. Also, systems 200 of this type do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

System 200 typically includes one or more of a WWAN transceiver 250 and a WLAN transceiver 260 for connecting to various networks, such as telecommunications networks and wireless base stations. Commonly, system 200 will include a touch screen 270 for data input and display. System 200 also typically includes various memory devices, for example flash memory 280 and SDRAM 290.

FIG. 1, for its part, depicts a block diagram of another example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may operate to receive various messages, e.g., text messages, email messages, voicemail messages and the like. The messages may be received by the device over a network connection, e.g., the Internet or a telecom network. The message contents (e.g., text content, audio content) may include one or more action items, as described herein.

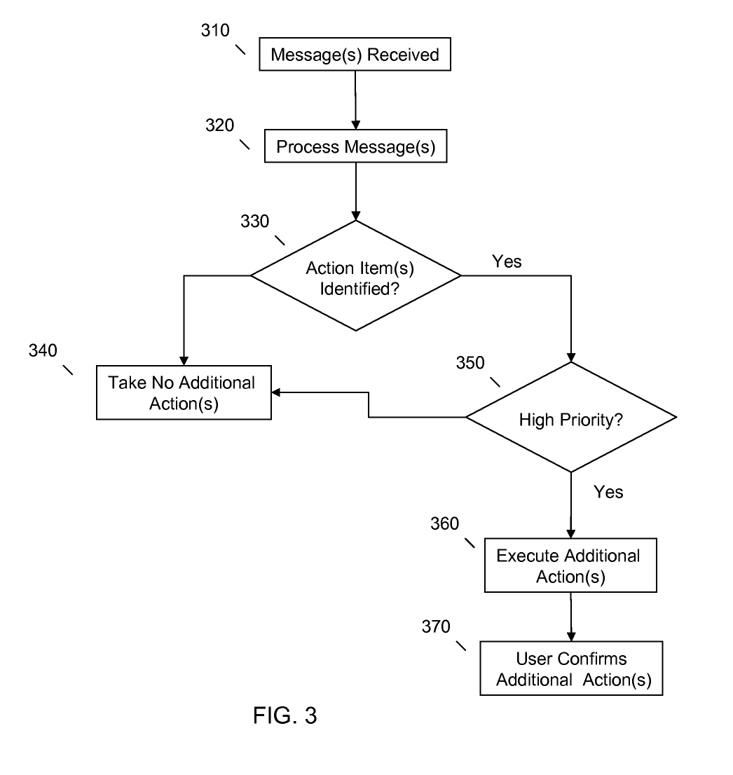

Referring to FIG. 3, an embodiment may receive messages 310 and thereafter process the messages 320 to identify action item(s) contained therein. Different processing may take place depending on the nature of the message. For example, messages that contain text content may be parsed to identify key word(s) or phrase(s), e.g., as compared to a known list of key words and phrases associated with action items. In another example, message content may first be processed to render the content into another form or format. For example, in the case of an audio message, e.g., voicemail, message audio content may be processed using a text-to-speech mechanism to render textual content that is in turn parsed to identify key word(s) or phrase(s) for comparisons. Other types of message content may be used to identify action items, for example time included in a message, an address included in the message, etc.

If an action item is not identified at 330, an embodiment may take no additional actions 340, e.g., over an above the usual notification of the device indicating generically that a message has been received. If however an action item has been identified at 330, an embodiment may execute additional action(s) 360, examples of which are described further herein.

Optionally, as described further herein, an embodiment may determine if the message action items are considered high priority at 350. For example, a message from a high priority contact (e.g., as determined from a user provided contact group or automatically determined, e.g., via a user's contact history, etc.) may be informative. Thus, an embodiment may treat messages containing action items from a high priority user differently. For example, if the action item message was received from a low priority contact (i.e., not from a high priority contact), an embodiment may take no additional action even though the message contains one or more action items. Alternatively, if the message is high priority (e.g., from a high priority user), an embodiment may then execute additional actions.

For example, a message containing an action item from a high priority contact may be processed, such as for example providing an appropriate automated response and/or adding a calendar entry. This permits a user to maintain control over which action items are processed, e.g., by defining users that are permitted to issue effective action items (i.e., those that will trigger additional actions such as an additional notification, etc.). As another example, an embodiment may determine the urgency of an action item as part of a priority determination. For example, if the action item identified is time-sensitive (e.g., indicates an action to be taken in a short amount of time) or refers to a location that is en route for the traveler, e.g., as sensed for example via a GPS service, the urgency would be high and thus an embodiment may determine that the action item is high priority.

As another option, an embodiment may permit the user control action(s) executed with respect to additional actions taken based on an identified action item. For example, an embodiment may prompt a user (e.g., via pop up window, etc.) for confirmation prior to fully executing an additional action, e.g., sending an automated response or adding an entry to the calendar. Thus, an embodiment may permit a user to further control how identified action items are processed/acted on prior to the action being completed.

With respect to additional actions that may be executed, these may take a variety of forms according to various embodiments. For example, over and above a generic indication that a message has been received, an embodiment may notify the user via a separate notification mechanism of the action item(s), potentially via multiple notification methods. This separate notification may take a variety of forms as well, for example utilizing a similar notification as a message received notification (e.g., an additional haptic vibration), a separate notification mechanism, e.g., an audible notification, or the like.

As another example, an embodiment may execute an additional action in the form of adding the action item(s) to a calendar entry, a to-do list, etc. This may be accomplished either alone or in combination with other additional actions, e.g., a separate notification.

An embodiment may translate or convert the action item into a response to the sender (of the message from which the action item was derived) or to another contact. For example, if the message sender asks if the user is available at a certain time, an embodiment may check the calendar to determine if the calendar is clear, and either automatically formulate a response and add the action item to the calendar or ask the recipient if an automatic response should be sent, a calendar entry made, etc. Thus, the action item may be translated into or take the form of a response a message. The response may be automatically sent if the recipient has allowed it (e.g., by a predefined policy). Additionally, other users (e.g., in the contacts list and associated with action item(s) in the message) may be included or copied on the response and/or send other messages in an automated way, e.g., an automated message notifying others mentioned in the message that the user has updated his or her calendar. Again, these messages may require user confirmation (370 of FIG. 3) prior to being executed (sent).

In this regard, an embodiment may ensure that the automated execution of additional tasks (360 of FIG. 3) remains under the user's ultimate control. For example, the user issuing the action item may be confirmed by the recipient user device prior to the action item being treated for executing additional action(s) as part of the priority determination at 350. For example, a high priority action item may take the form of a parent-child message in which the parent is a confirmed or high priority contact on the child's device. Thus, if a parent sends his or her child a text message stating that the child needs to be home by a certain time, the message would be parsed, the action item identified, the priority of the action item confirmed based on the user's priority status, and a reminder would be set to the child's device at that time. The recipient device may therefore be configured to include a predetermined “trusted” group of contacts, e.g. Family, Spouse, Children, etc., with varying levels of automatic responses or other additional action execution(s) pre-authorized.

Sender priority may be configured by the user in contacts/groups (e.g. family, boss, coworker, etc). Based on the responsiveness to a particular contact's messages, each sender's priority may be automatically increased or decreased by an embodiment, and this automated priority determination may be user-modifiable, e.g., via user input confirming or re-organizing a trusted group list and/or a group member's permissions with regard to additional actions.

It should be noted that although a receipt of a single message has been used as a convenient example for the purpose of description, various embodiments are not so limited. For example, if multiple separate messages from the same contact of sender are received within a predetermined time range, the processing may combine the messages in an effort to identify the action item(s), to confirm priority thereof, to refine what action(s) should be executed and the like. Thus, the content of multiple messages and/or multiple contacts or senders including common or associated action items may be utilized to determine appropriate additional action(s) to be executed by an embodiment.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, a message directed to a human recipient;
processing, using one or more processors of the information handling device, the message to identify one or more action items contained in content of the message; and
executing one or more additional actions based on the one or more action items identified from the content of the message.

2. The method of claim 1, wherein the processing comprises:
parsing the content of the message to analyze one or more of a word and a phrase contained therein; and
comparing the one or more of a word and a phrase to a predetermined set of key words and key phrases associated with one or more action items.

3. The method of claim 2, wherein the receiving a message comprises receiving two or more messages from a sender within a predetermined time; and wherein processing the message comprises analyzing in combination one or more of words and phrases in the two or more messages to identify the one or more action items.

4. The method of claim 1, wherein the executing one or more additional actions based on the one or more action items identified comprises determining an urgency of an action item.

5. The method of claim 1, further comprising designating one or more contacts as a high priority contact permitted to create action items.

6. The method of claim 5, wherein the executing one or more additional actions based on the one or more action items identified comprises:
determining if a sender of the message is a high priority contact; and
after determining the sender of the message is not a high priority contact, taking no additional action.

7. The method of claim 1, wherein the executing one or more additional actions based on the one or more action items identified comprises providing a separate notification to a user of the one or more action items identified.

8. The method of claim 1, wherein the executing one or more additional actions based on the one or more action items identified comprises adding a calendar entry on an electronic calendar application based on an action item.

9. The method of claim 1, wherein the executing one or more additional actions based on the one or more action items identified comprises translating the action item into a response to the sender.

10. The method of claim 9, further comprising providing an opportunity for user confirmation of the response prior to sending the response to the sender.

11. An information handling device, comprising:
one or more processors;
a memory device accessible to the one or more processors and storing code executable by the one or more processors to:
receive a message directed to a human recipient;
process the message to identify one or more action items contained in content of the message; and
execute one or more additional actions based on the one or more action items identified from the content of the message.

12. The information handling device of claim 11, wherein to process comprises:
parsing the content of the message to analyze one or more of a word and a phrase contained therein; and
comparing the one or more of a word and a phrase to a predetermined set of key words and key phrases associated with one or more action items.

13. The information handling device of claim 12, wherein to receive a message comprises receiving two or more messages from a sender within a predetermined time; and wherein to process the message comprises analyzing in combination one or more of words and phrases in the two or more messages to identify the one or more action items.

14. The information handling device of claim 11, wherein to execute one or more additional actions based on the one or more action items identified comprises determining an urgency of an action item.

15. The information handling device of claim 11, further comprising designating one or more contacts as a high priority contact permitted to create action items.

16. The information handling device of claim 15, wherein to execute one or more additional actions based on the one or more action items identified comprises:
determining if a sender of the message is a high priority contact; and
after determining the sender of the message is not a high priority contact, taking no additional action.

17. The information handling device of claim 11, wherein to execute one or more additional actions based on the one or more action items identified comprises providing a separate notification to a user of the one or more action items identified.

18. The information handling device of claim 11, wherein to execute one or more additional actions based on the one or more action items identified comprises adding a calendar entry on an electronic calendar application based on an action item.

19. The information handling device of claim 11, wherein to execute one or more additional actions based on the one or more action items identified comprises translating the action item into a response to the sender.

20. A program product, comprising:
a storage device having computer readable program code stored therewith, the computer readable program code comprising:
computer readable program code configured to receive, at an information handling device, a message directed to a human recipient;
computer readable program code configured to process, using one or more processors of the information handling device, the message to identify one or more action items contained in content of the message; and
computer readable program code configured to execute one or more additional actions based on the one or more action items identified from the content of the message.
